(19) United States
(12) Patent Application Publication
(10) Pub. No.: US 2013/0117762 A1
(43) Pub. Date: May 9, 2013

(54) INFORMATION PROCESSING APPARATUS, INFORMATION PROCESSING METHOD, AND COMPUTER PRODUCT

(71) Applicant: FUJITSU LIMITED, Kawasaki-shi (JP)

(72) Inventors: Koichiro YAMASHITA, Hachioji (JP); Hiromasa YAMAUCHI, Kawasaki (JP); Takahisa SUZUKI, Kawasaki (JP); Koji KURIHARA, Kawasaki (JP)

(73) Assignee: FUJITSU LIMITED, Kawasaki-shi (JP)

(21) Appl. No.: 13/730,161

(22) Filed: Dec. 28, 2012

Related U.S. Application Data
(63) Continuation of application No. PCT/JP2010/061190, filed on Jun. 30, 2010.

(51) Int. Cl. G06F 9/54

(52) U.S. Cl. CPC G06F 9/54
USPC 719/313

(57) ABSTRACT

An information processing apparatus includes a processor that is configured to detect a changeover request in a first mode in which a first OS executes a process that includes a second OS different from the first OS; and change the first mode over to a second mode in which the second OS executes a process that includes the first OS, upon detecting the changeover request.

### CROSS REFERENCE TO RELATED APPLICATIONS

This application is a continuation application of International Application PCT/JP2010/061190, filed on Jun. 30, 2010 and designating the U.S., the entire contents of which are incorporated herein by reference.

### FIELD

The embodiments discussed herein are related to an information processing apparatus, an information processing method, and a computer product.

### BACKGROUND

A conventional technique of enabling a single processor system to execute multiple operating systems (OSs) is known. When services available to a user depend on OSs that operate independently to implement each service, this technique is applied to implement these OSs on a single processor system. Technologies for implementing such a mechanism are known as a virtual machine (VM), hybrid OS, etc.

The VM refers to software executed on virtual resources created by giving a CPU, memory, etc., virtual forms. Software that gives resources a virtual form is referred to as hypervisor. Incorporating multiple VMs into a single processor system allows execution of two or more OSs. A processor system equipped with VMs causes one of the OSs in the system to serve as a master OS and thus, has a mechanism that performs overall management of the processor system.

A hybrid OS is a technique according to which a slave OS different from a master OS is executed as one process of the master OS serving as the fundamental OS. In an environment requiring real-time performance, such as an integrated system, a real-time OS is adopted as the master OS and a general-purpose OS is adopted as a slave OS in some cases. For example, the real-time OS executes a real-time process for which high processing capability is required, while the general-purpose OS executes processes other than a real-time process. Consequently, software assets of the general-purpose OS can be diverted to other purposes while maintaining real-time performance and thus, enabling a reduction in development costs.

For example, a technique using the hybrid OS is disclosed, according to which when a screen controlled by a master OS and a screen controlled by a slave OS differ in resolution, the screens can be switched at high speed (see, e.g., Japanese Laid-Open Patent Publication No. H5-181443).

Another technique related to the hybrid OS is disclosed, according to which, a memory management table is changed and processing by a master OS and processing by a slave OS are switched so that the salve OS is kept operable even if the master OS has a trouble (see, e.g., Japanese Laid-Open Patent Publication No. 2007-334572).

According to the above conventional techniques, the VM needs a hypervisor that switches the OSs. A system equipped with a hypervisor tends to have large-scale software architecture, which is a problem. The hybrid OS can be simpler in system packaging than the VM. However, according to the hybrid OS, the slave OS is a process executed on the master OS and the cycle of processor assignment is under the control of the master OS. For this reason, when the slave OS executes a process of a high priority level in a state where the master OS has set the overall priority level of the slave OS to a low level, the cycle at which the process is assigned to a processor remains low, which is a problem.

According to the techniques of Japanese Laid-Open Patent Publication Nos. H5-181443 and 2007-334572, if a process by the slave OS is given a high priority level, the priority level of the master OS drops relatively. When the process by the slave OS, which is given a high priority level, accesses a device, the process makes access via the master OS. Consequently, the master OS having a lower priority level becomes the source of a bottleneck that delays execution of the process, which is a problem.

### SUMMARY

According to an aspect of an embodiment, an information processing apparatus includes a processor that is configured to detect a changeover request in a first mode in which a first OS executes a process that includes a second OS different from the first OS; and change the first mode over to a second mode in which the second OS executes a process that includes the first OS, upon detecting the changeover request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a hardware configuration of an information processing apparatus 100 according to an embodiment;

FIG. 2 is an explanatory diagram of a state where the information processing apparatus 100 has switched Oss;

FIG. 3 is a block diagram of functions of the information processing apparatus 100;

FIG. 4 is an explanatory diagram of an example of display that results when OSs are switched by the information processing apparatus 100;

FIG. 5 is an explanatory diagram of one example of memory address spaces;

FIG. 6 is an explanatory diagram of a state of dispatch of application software at the time of OS switching;

FIG. 7 is an explanatory diagram of a schematic of an OS switching process; and

FIG. 8 is a flowchart of the OS switching process.

### DESCRIPTION OF EMBODIMENTS

Preferred embodiments of an information processing apparatus, an information processing method, and an information processing program will be explained in detail with reference to the accompanying drawings.

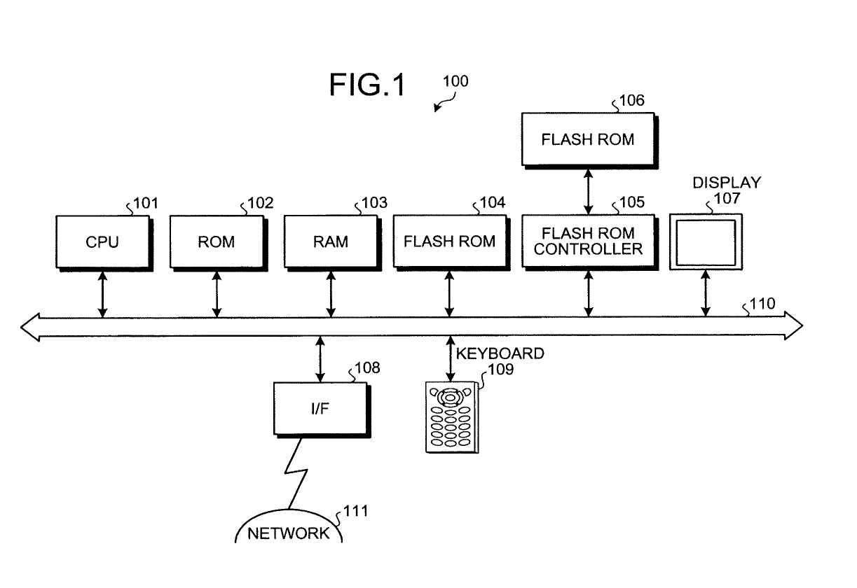

FIG. 1 is a block diagram of a hardware configuration of an information processing apparatus 100 according to an embodiment. As depicted in FIG. 1, an information processing apparatus 100 includes multiple central processing unit (CPU) 101, read-only memory (ROM) 102, random access memory (RAM) 103, flash ROM 104, a flash ROM controller 105, and flash ROM 106. The information processing apparatus 100 includes a display 107, an interface (I/F) 108, and a keyboard 109, as input/output devices for the user and other devices. The components of the multi-core system 100 are respectively connected by a bus 110.

The CPU 101 governs overall control of the information processing apparatus 100. The ROM 102 stores therein programs such as a boot program. The RAM 103 is used as a work area of the CPUs 101. The flash ROM 104 stores system software such as an OS, and application software.

The flash ROM controller 105, under the control of the CPU 101, controls the reading and writing of data with respect to the flash ROM 106. The flash ROM 106 stores therein data written under control of the flash ROM controller 105. Examples of the data include image data and video data received by the user of the information processing apparatus through the I/F 108. A memory card, SD card and the like may be adopted as the flash ROM 106.

The display 107 displays, for example, data such as text, images, functional information, etc., in addition to a cursor, icons, and/or tool boxes. A thin-film-transistor (TFT) liquid crystal display and the like may be employed as the display 107.

The I/F 108 is connected to a network 111 such as a local area network (LAN), a wide area network (WAN), and the Internet through a communication line and is connected to other apparatuses through the network 111. The I/F 108 administers an internal interface with the network 111 and controls the input and output of data with respect to external apparatuses. For example, a modem or a LAN adaptor may be employed as the I/F 108.

The keyboard 109 includes, for example, keys for inputting letters, numerals, and various instructions and performs the input of data. Alternatively, a touch-panel-type input pad or numeric keypad, etc. may be adopted.

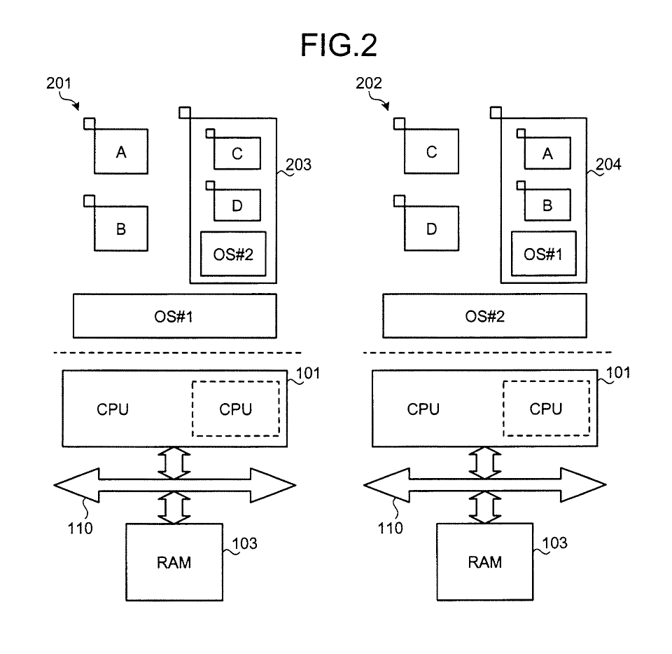

FIG. 2 is an explanatory diagram of a state where the information processing apparatus 100 has switched OSs. The information processing apparatus 100 can take two modes including a mode 201 in which an OS #1 is being executed as a master OS and a mode 202 in which an OS #2 is being executed as the master OS.

The OSs #1 and #2 are OSs that operate on the CPU 101. For example, the OSs #1 and #2 have an OS function of providing a library used by processes and have a function of scheduling processes.

The master OS is the OS that controls the information processing apparatus 100. A slave OS is an OS executed as one process of the master OS. By executing the slave OS, the information processing apparatus 100 executes multiple OSs simultaneously. Hence, the information processing apparatus 100 assumes an aspect of a multi-core processor having multiple cores.

The information processing apparatus 100 in the mode 201 causes the OS #1 to serve as the master OS, and under the control of the OS #1, executes a process A, a process B, and a process 203 including a process by the OS #2. In the process 203, the information processing apparatus 100 executes a process C and a process D under the control of the OS #2. When detecting a changeover request, the information processing apparatus 100 changes the mode 201 over to the mode 202 by inter-switching the master OS and the slave OS.

The information processing apparatus 100 in the mode 202 causes the OS #2 to serve as the master OS, and under the control of the OS #2, executes the process C, the process D, and a process 204 including a process by the OS #1. In the process 204, the information processing apparatus 100 executes the process A and the process B under the control of the OS #1.

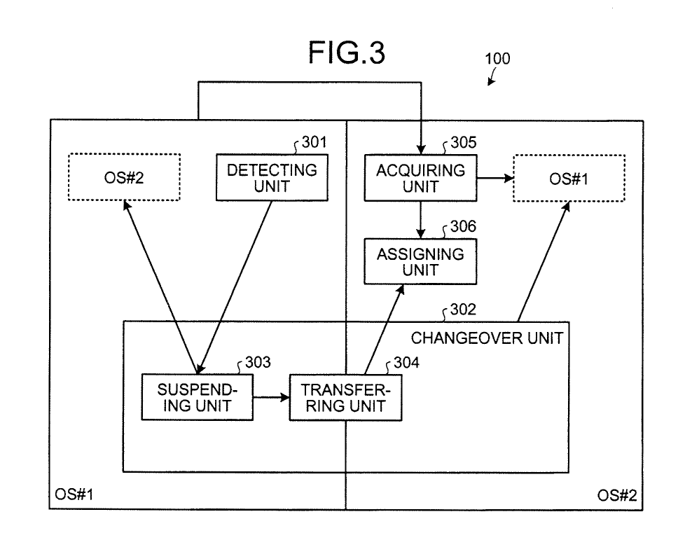

The functions of the information processing apparatus 100 will be described. FIG. 3 is a block diagram of functions of the information processing apparatus 100. The information processing apparatus 100 includes a detecting unit 301, a changeover unit 302, a suspending unit 303, a transferring unit 304, an acquiring unit 305, and an assigning unit 306. These functions (detecting unit 301 to assigning unit 306) serving as a control unit are implemented by causing the CPU 101 to execute programs stored in memory devices. The memory devices are, for example, the ROM 102, RAM 103, flash ROM 104, flash ROM 106, etc., as depicted in FIG. 1. The functions may be implemented by causing another CPU to execute the programs via the I/F 108.

The detecting unit 301 has a function of detecting a changeover request in a first mode in which a first OS executes a process that includes a second OS different from the first OS. For example, the detecting unit 301 detects a changeover request issued by a user operation, etc., in the mode 201 in which the OS #1 serving as the master OS executes the process 203 that includes the OS #2 serving as the slave OS. The result of the detection is stored in a memory area, such as a register of the CPU 101 and the RAM 103.

The changeover unit 302 has a function of changing a first mode over to a second mode in which the second OS executes a process that includes the first OS, when the detecting unit 301 detects a changeover request. The changeover unit 302 may change the first mode over to the second mode when the transferring unit 304 transfers execution authority to the second OS. For example, the changeover unit 302 uses a pointer to the process 204 that includes the OS #1 and changes the mode of the information processing apparatus 100 from the mode 201 over to the mode 202 in which the OS #2 executes the process 204, the pointer being secured by the transferring unit 304.

The changeover unit 302 may change the first mode over to the second mode where an interface-related process by the second OS is also executed. A user-interface-related process includes, for example, a key event process for the keyboard 109 and a mouse event process for a case where the display 107 is a touch panel. For example, the changeover unit 302 further executes the key event process or the mouse event process of the OS #2 in the mode 202 in which the OS #2 serves as the master OS. Changeover information may be stored in a memory area, such as the register of the CPU 101 and the RAM 103.

The suspending unit 303 has a function of suspending the process that includes the second OS, when the detecting unit 301 detects a changeover request. For example, when a changeover request is detected, the suspending unit 303 suspends the process 203. When the process 203 is suspended, the process 203 is no longer assigned to the CPU 101 but information of the process 203 is present in the RAM 103.

The suspending unit 303 may suspend a user-interface-related process by the first OS. For example, the suspending unit 303 suspends a key event process and a mouse event process by the OS #1. Information of suspension of the process or the user-interface-related process is stored in a memory area, such as the register of the CPU 1 and the RAM 103.

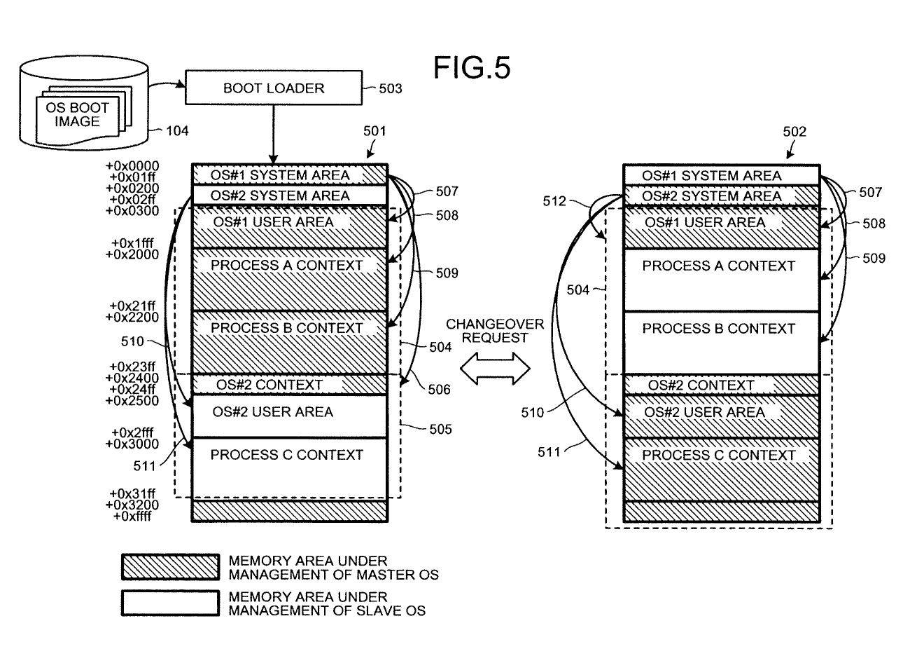

The transferring unit 304 has a function of transferring execution authority over the CPU 101 from the first OS to the second OS when the suspending unit 303 suspends the process that includes the second OS. For example, when the suspending unit 303 suspends the process 203, the transferring unit 304 transfers the execution authority from the OS #1 to the OS #2. As the result of the transfer of the execution authority, the master OS is changed from the OS #1 over to the OS #2. Actually, the execution authority is transferred from the OS #1 to the OS #2 when the OS #1 releases a pointer to the process 203 and the OS #2 secures a pointer to the process 204. The details of this operation will be described hereinafter with reference to FIG. 5. Information of the transfer of the execution authority and changeover of the master OS is stored in a memory area, such as the register of the CPU 1 and the RAM 103.

The acquiring unit 305 has a function of acquiring a user area for the first OS and a second memory area assigned to a process executed by the first OS, from a system area for the first OS assigned to a given position in a first memory area accessed by the processor. The first memory area is a memory area accessed by the CPU, such as the ROM 102 and ROM 103.

The system area is a memory area used by the OS, device driver, etc. The user area is an area assigned to the OS other than the system area, and is used by a process executed by the OS. The given position to which the system area is assigned may be determined to be any position if the position does not move after the start of the information processing apparatus 100.

For example, a system area for the OS #1 may be assigned to the initial address of the RAM 103. A system area for the OS #2 may be assigned to a memory area next to a memory area assigned as the system area for the OS #1. A second memory area assigned to a process is a memory area assigned as the context of the process. A process stores data used by the process, such as a value in the register of the CPU, a program counter, and a stack pointer, in the context.

For example, the acquiring unit 305 acquires a user area for the OS #1 and a memory area assigned as the contexts of the processes A and B, from the system area for the OS #1. For example, the acquiring unit 305 acquires a pointer that points out the memory area. Information of the acquired areas is stored in a memory area, such as the register of the CPU 1 and the RAM 103.

The assigning unit 306 has a function of assigning at least a partial memory area among of a memory area given by excluding the second memory area from the user area for the first OS acquired by the acquiring unit 305, to the second OS when the transferring unit 304 transfers the execution authority to the second OS. For example, the assigning unit 306 assigns at least a partial memory area among an unused memory area given by excluding the memory area assigned as the contexts of the processes A and B from the user area for the OS #1, as a user area for the OS #2.

The assigning unit 306 may assign the entire unused memory area to the second OS or may assign part of the unused memory area. For example, a case is assumed where the user area for the OS #1 is 7 [M bytes], the user area for the OS #2 is 4 [M bytes], and the memory area assigned as the contexts of the processes A and B is 3 [M bytes] in total. In this case, the assigning unit 306 may assign the entire unused portion of user area for the OS #1 of 4 [M bytes] to the user area for the OS #2 or may spare a portion of 1 [M bytes] for the user area for the OS #1 while assigning the remaining portion of 3 [M bytes] to the user area for the OS #2, thereby giving the user area for the OS #2 a total size of 4+3=7 [M bytes].

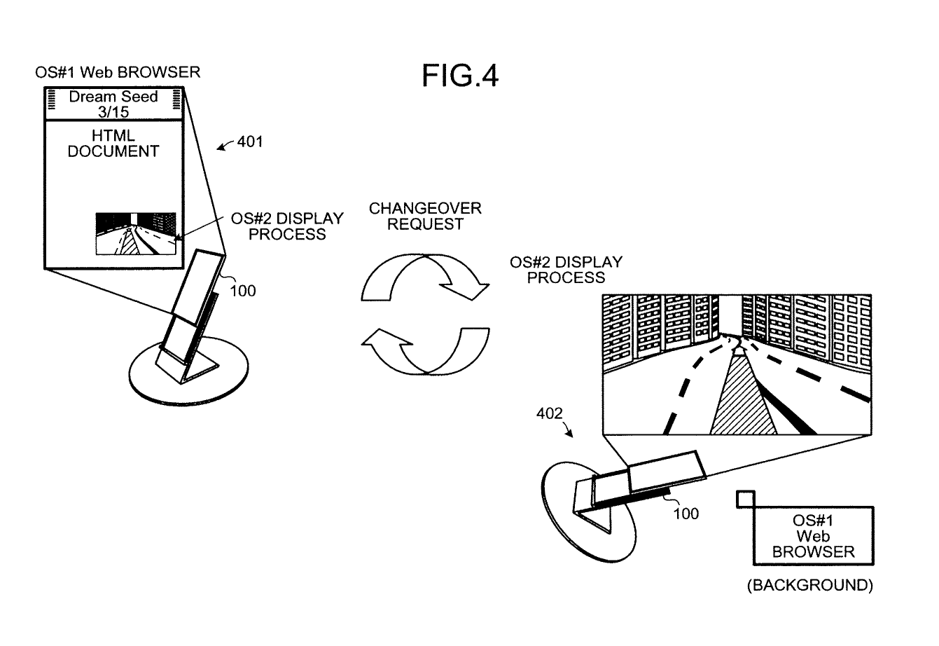

FIG. 4 is an explanatory diagram of an example of display that results when OSs are switched by the information processing apparatus 100. The information processing apparatus 100 in a mode 401 and a mode 402 represents the information processing apparatus 100 that executes a Web browser as the process A and a map display process as the process C in the mode 201 and the mode 202, respectively. The information processing apparatus 100 in the mode 401 executes the Web browser in the foreground, displaying a hypertext markup language (HTML) document. The information processing apparatus 100 also displays the map display process as a small window of the web browser. The map display process is a service on the OS #2 and is executed in the background at a low priority level.

A changeover request is issued by an operation by a user on the Web browser, such as a click of the map display process. When the changeover request is issued, the information processing apparatus 100 changes the mode from the mode 401 over to the mode 402, which switches the OS #1 as the master OS and the OS #2 as the slave OS for one another.

The information processing apparatus 100 in the mode 402 executes the map display process in the foreground and the Web browser in the background. For example, when an upward arrow key of the keyboard 109 is pressed, the information processing apparatus 100 reports a key event to the map display process through a key event process by the OS #2. The map display process makes a request for a screen image that displays a forward direction on the map based on the key event, in response to which the information processing apparatus 100 acquires the screen image through the I/F 108 and displays the acquired image on the display 107. At this time, the OS #2 serves as the master OS. The OS #2, therefore, can directly access a driver that controls the keyboard 109, the I/F 108, and the display 107. Hence, a fast graphic action can be made with less delay from the instant that the upward arrow key is pressed.

According to a conventional example of an information processing apparatus, the OS #2 is the slave OS subordinate to the OS #1 and consequently, the OS #2 has to access the OS #1 first in order to access the driver that controls the keyboard 109, the I/F 108, and the display 107. When giving the OS #2 high priority and trying to perform a fast graphic action, therefore, the information processing apparatus of the conventional example first accesses the OS #1 which becomes slow in processing relative to the OS #2. As a result, fast display is not achieved.

FIG. 5 is an explanatory diagram of one example of memory address spaces. FIG. 5 depicts a memory address space 501 and a memory address space 502 that indicate the memory contents of the RAM 103. The information processing apparatus 100 loads an OS boot image stored in the flash ROM 104, etc., onto the RAM 103 through a boot loader 503. The address spaces of the RAM 103 of FIG. 5 are depicted as areas offset to the initial address of the RAM 103. The memory address space 501 indicates the memory contents of the RAM 103 in the mode 201, and the memory address space 502 indicates the memory contents of the RAM 103 in the mode 202. It is assumed in FIG. 5 that the information processing apparatus 100 is started in the mode 201.

The boot loader 503 assigns system areas that are boot-up points for the OS #1 and the OS #2, 0x0000 to 0x01ff and 0x0200 to 0x02ff as respective areas of fixed sizes. The boot loader also assigns a memory area 504 ranging from 0x0300 to 0x23ff as a user area for the OS #1 and assigns a memory area ranging from 0x2400 to 0x31ff as a memory area 505 used by the OS #2. The assigned memory area 505 can be regarded as the context of the process 203 including the process by the OS #2.

Following the area assignment, the OS #1 stores the initial address of the area assigned as the context of the process 203, in a pointer 506. The remaining unassigned area of 0x3200 to 0xffff is used as a user area for the OS #1, and is put under the management of the OS #1. As a result, the user area for the OS #1 as a whole becomes a discontinuous memory area, which is, however, managed in memory management units (MMUs).

From the memory area 505, the OS #2 assigns the context of the OS #2, which serves as a work area for the OS #2, to 0x2400 to 0x24ff and assigns a user area for the OS #2 to 0x2500 to 0x31ff.

From an unused area of the user area for the OS #1, the OS #1 assigns the context of the process A to 0x2000 to 0x21ff and assigns the context of the process B to 0x2200 to 0x23ff. From the user area for the OS #2 of 0x2500 to 0x31ff, the OS #2 assigns the context of the process C to 0x3000 to 0x31ff.

Following the area assignment, the OS #1 stores the initial address of the user area for the OS #1 in a pointer 507. The OS #1 also stores the initial address of the context of the process A in a pointer 508 and stores the initial address of the context of the process B in a pointer 509. The pointers 506 to 509 storing initial addresses therein are stored in the system area for the OS #1. The pointers 508 and 509 on processes are stored also in a process dispatch table 601, which will be described later.

In the same manner, the OS #2 stores the initial address of the user area for the OS #2 in a pointer 510 and stores the initial address of the context of the process C in a pointer 511. The pointers 510 to 511 storing initial addresses therein are stored in the system area for the OS #2. The pointer 511 on processes are stored also in the process dispatch table 601.

When a changeover request is issued by the user, the information processing apparatus 100 changes the memory address space thereof from the memory address space 501 over to the memory address space 502. No change is made between the memory address spaces 501 and the memory address space 502 in terms of assigned areas as the memory contents of the RAM 103, but some pointers are changed. For example, the OS #1 releases the pointer 506 storing therein the initial address of the process 203, and also releases the unused memory area of 0x3200 to 0xffff.

Subsequently, the OS #2 regards the user area for the OS #1, context of the process A, and context of the process B of the memory area 504 under the management of the OS #1, as the context of the process 204, and stores the initial address of the user area for the OS #1 in a pointer 512, i.e., the OS #1 has released the pointer 506 to the context of the process 203 and the OS #2 has secured the pointer 512 to the context of the process 204. Hence, the execution authority has been transferred from the OS #1 to the OS #2. The OS #2 now manages the unused area of 0x3200 to 0xffff. As a result, the OS #2 newly serving as the master OS can assign a memory area larger than a memory area assigned in the mode 201, to a newly started process or a process requesting a larger memory area.

In the example of FIG. 5, the case of the information processing apparatus 100 equipped with two OSs is described. When the information processing apparatus 100 is equipped with N OSs, the boot loader 503 assigns a system area for the OS #1, a system area for the OS #2, . . . , and a system area for an OS #N as areas of fixed sizes in the RAM 103. The boot loader 503 then assigns a user area for the OS #1, a user area for the OS #2, . . . , and a user area for an OS #N as areas of variable sizes in the RAM 103.

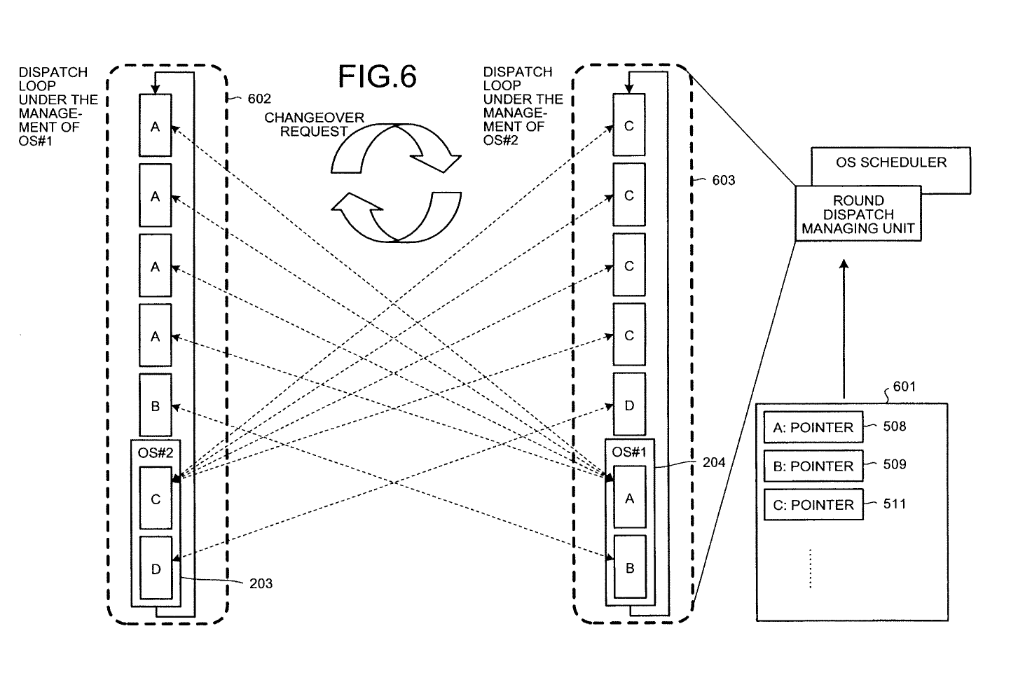

FIG. 6 is an explanatory diagram of a state of dispatch of application software at the time of OS switching. The process dispatch table 601 stores therein pointers to the contexts of processes executed at all OSs. For example, the process dispatch table 601 stores therein the pointer 508 to the process A, the pointer 509 to the process B, the pointer 511 to the process C, and so on.

A round dispatch managing unit incorporated in the scheduler of each OS refers to the process dispatch table 601. The round dispatch managing unit can acquire a pointer to the context of a process by referring to the process dispatch table 601. Using a pointer to the context of a process, the round dispatch managing unit reconstructs a dispatch loop based on scheduling.

For example, the scheduler of the OS #1 constructs a dispatch loop 602 by causing the round dispatch managing unit to refer to the process dispatch table 601. The dispatch loop 602 is constructed so that the process A, the process B, and the process 203 are executed through time-slice processing and so that the process A is given a high priority level.

When a changeover request is issued by a user operation, etc., the scheduler of the OS #2 constructs a dispatch loop 603 by causing the round dispatch managing unit to refer to the process dispatch table 601. The dispatch loop 603 is constructed so that the process C, the process D, and the process 204 are executed through time-slice processing and so that the process C is given a high priority level. In this manner, by referring to the process dispatch table 601, the scheduler of each OS can easily perform priority level control.

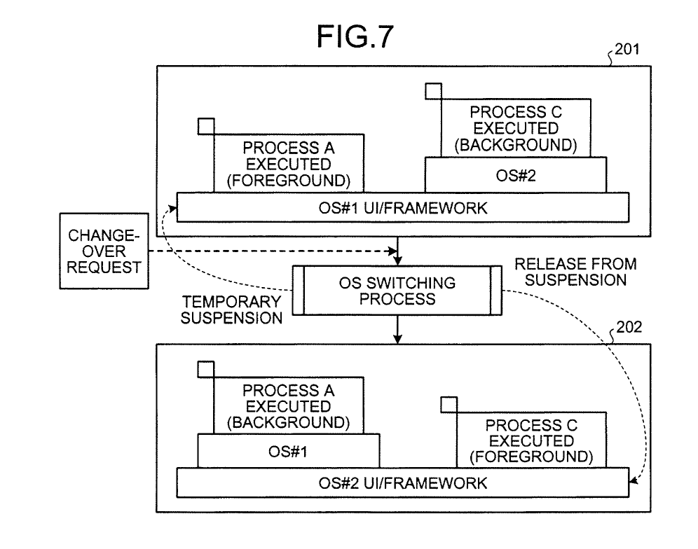

FIG. 7 is an explanatory diagram of a schematic of an OS switching process. The information processing apparatus 100 in the mode 201 executes each process based on a user interface (UI) and a framework provided by the OS #1. In FIG. 7, for example, the process A and the OS #2 are executed in the foreground through the UI of the OS #1. In the OS #2, the process C is executed in the background. For example, when the UI provided by the OS #1 is a GUI, the OS #1 moves an arrow icon, etc. by a pointing device to execute a mouse event process and thereby, handles a request to a process by the user.

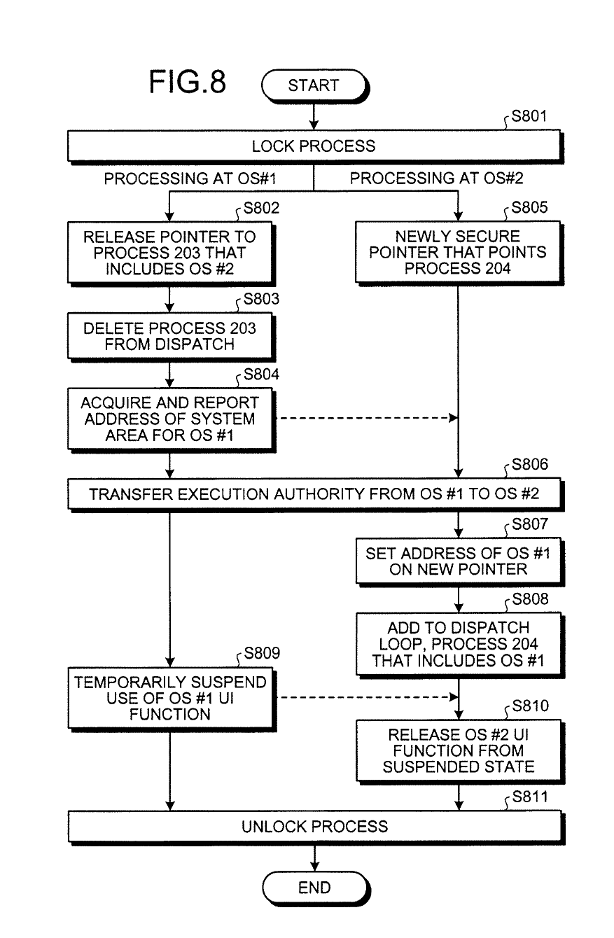

When a changeover request is issued by the user, the information processing apparatus 100 executes the OS switching process. The details of the OS switching process will be described later with reference to FIG. 8. In the OS switching process, the UI of the OS #1 is suspended temporarily and the UI of the OS #2 is released from the suspended state.

When the information processing apparatus 100 is in the mode 202 following the end of the OS switching process, the information processing apparatus 100 executes each process based on the UI and framework provided by the OS #2. In FIG. 7, for example, the process C and the OS #1 are executed in the foreground through the UI of the OS #2. In the OS #1, the process A is executed in the background.

FIG. 8 is a flowchart of the OS switching process. The flowchart of the OS switching process of FIG. 8 depicts a case where the information processing apparatus 100 changes the mode from the mode 201 over to the mode 202. When the information processing apparatus 100 changes the mode from the mode 202 over to the mode 201, the process by the OS #2 and the process by the OS #1 are inter-switched, i.e., following the process at step S801, the information processing apparatus 100 executes steps S802, S803, S804, and S809 as processes by the OS #2, and executes steps S805, S807, S808, and S810 as processes by the OS #1.

The OS #1 executes a lock process by the user (step S801). The information processing apparatus 100 having executed the lock process does not allow execution of an external interrupt including user operation. Following the lock process, the OS #1 releases a pointer to the process 203 that includes the OS #2 (step S802). Subsequently, the OS #1 deletes the process 203 from a dispatch loop under the management of the OS #1 (step S803). For example, the OS #1 deletes the pointer 506 indicating the context of the process 203.

The OS #1 then acquires the address of the system area that is a boot-up point for the OS #1 and reports the acquired address to the OS #2 (step S804). Following the report, the CPU 101 transfers the execution authority from the OS #1 to the OS #2 (step S806). As a result, the master OS is changed from the OS #1 over to the OS #2. Actually, the execution authority is transferred through a process such that the OS #1 deletes the pointer to the process 203 from the system area for the OS #1 at step S803 and the OS #2 secures a pointer to the process 204 at step S806. When the execution authority is transferred, the CPU 101 releases at least a partial memory area among an unused memory area from the user area for the OS #1, and assigns the released memory area as the user area for the OS #2.

The OS #2 newly secures the pointer that points the process 204 (step S805) and acquires a pointer to the system area for the OS #1 through the report from the OS #1. Having acquired the pointer, the OS #2 sets the address of the OS #1 on the pointer as a new pointer (step S807). For context of the process 204, the address of the user area for the OS #1, the address being acquired from the system area for the OS #1. Thus, the pointer 512 indicates the context of the process 204.

Following the address setting, the OS #2 adds the process 204 that includes the OS #1 to a dispatch loop under the management of the OS #2 (step S808). In a case of a mechanism according to which when the pointer is newly secured by the process at step S805, the new pointer is added to the dispatch loop, the process 204 is already added to the dispatch loop by the process at step S807. In such a case, the OS #2 has no need to execute the process at step S808. After the addition of the process 204 to the dispatch loop, the OS #1 temporarily suspends use of the UI function (step S809), while the OS #2 releases the UI function from the suspended state (step S810).

After the process at step S809 by the OS #1 and the process at step S810 by the OS #2, the OS #2 executes an unlock process from the user (step S811), and ends the OS switching process. The information processing apparatus 100 having executed the unlock process allows external interrupts including user operations.

As described, according to the information processing apparatus, the information processing method, and the information processing program, when a changeover request is detected, the OS #1 serving as the master OS is set as the slave OS and the OS #2 serving as the slave OS is set as the master OS. As a result, according to the information processing apparatus, when the slave OS is given a higher priority level, the slave OS serving as the master OS can directly access a device without a need of accessing the original master OS present in an access path from the slave OS to the device. This makes access of the device by the slave OS faster. Hence, the information processing apparatus can eliminate a delay in a process involving access of a device by the OS #2, which is originally the slave OS and thereby, improves the response performance of the OS #2.

When a changeover request is detected, the information processing apparatus may suspend the process that includes the OS #2 executed by the OS #1 and transfer the execution authority from the OS #1 to the OS #2, thereby setting the OS #2 and the OS #1 as the master OS and the slave OS, respectively. Through this process, the information processing apparatus can switch OSs while avoiding an indefinite loop situation where the OS #2 is subordinate to the OS #1 and at the same time, the OS #1 is subordinate to the OS #2.

When OSs are switched, the information processing apparatus may acquire the user area for the OS #1 and the memory area assigned to a process executed by the OS #1, from the system area for the OS #1 assigned to a given position, and assign an unused portion of the user area for the OS #1 to the OS #2, thereby enabling the information processing apparatus to realize dynamic memory assignment such that when the OS originally serving as the slave OS becomes the master OS, the OS is allowed to use a memory area larger than the memory area set for the OS as the slave OS.

When OSs are switched, the information processing apparatus may suspend the UI function of the OS #1 and release the UI function of the OS #2 from the suspended state. As a result, when the information processing apparatus is an apparatus with a limited display area, such as cellular phone, the information processing apparatus limits windows to be operated, to a window of the master OS displayed on the screen when the master-slave relation between the OSs is switched. In this manner, by suspending the UI of the slave OS not displaying an image on the screen, the processing volume can be reduced.

By switching the master-slave relation between the OSs, the information processing apparatus can improve response performance. For example, a case is assumed where a process switching interval of an OS #M serving as the master OS is τm, the number of processes is M, a process switching interval of an OS #N serving as a slave OS is τn, and the number of processes is N. In a case of an apparatus in which the master-slave relation between OSs is fixed, a time of Mτm+Nτn is required to call a process present in the OS #N in the worst case. According to the information processing apparatus of the embodiment, processes can be switched in a time of Nun as a result of switching of the master-slave relation between OSs.

The information processing method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

The information processing apparatus, the information processing method, and the information processing program offer an effect that when OSs are switched, a delay in processing by an OS originally serving as a slave OS before the switching is eliminated to improve response performance.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising a processor configured to:
detect a changeover request in a first mode in which a first OS executes a process that includes a second OS different from the first OS; and
change the first mode over to a second mode in which the second OS executes a process that includes the first OS, upon detecting the changeover request.

2. The information processing apparatus according to claim 1, the processor further configured to:
suspend the process that includes the second OS, upon detecting the changeover request; and
transfer execution authority over a given processor, from the first OS to the second OS, upon suspending the process that includes the second OS, wherein
the processor, when transferring the execution authority to the second OS, changes the first mode over to the second mode.

3. The information processing apparatus according to claim 2, the processor further configured to:
acquire a user area for the first OS and a second area assigned to a process executed by the first OS, from a system area for the first OS assigned to a given position in a first memory area accessed by the given processor; and
assign to the second OS, at least a partial memory area from a memory area given by excluding the second memory area from the user area for the first OS, upon transferring the execution authority to the second OS.

4. The information processing apparatus according to claim 2, wherein
the processor further suspends a user-interface-related process by the first OS, and
the processor changes the first mode over to the second mode wherein an interface-related process by the second OS is additionally executed.

5. An information processing method executed by a processor, the information processing method comprising:
detecting a changeover request in a first mode in which a first OS executes a process that includes a second OS different from the first OS; and
changing the first mode over to a second mode in which the second OS executes a process that includes the first OS, upon detecting the changeover request.

6. A computer-readable recording medium storing a program that causes a processor to execute an information processing process comprising:
detecting a changeover request in a first mode in which a first OS executes a process that includes a second OS different from the first OS; and
changing the first mode over to a second mode in which the second OS executes a process that includes the first OS, upon detecting the changeover request.
